(19) United States
(12) Patent Application Publication
(10) Pub. No.: US 2021/0350092 A1
(43) Pub. Date: Nov. 11, 2021

(54) CONTROL PROTOCOL FOR MULTI-PROTOCOL TRANSPONDER

(71) Applicant: NEOLOGY, INC., San Diego, CA (US)

(72) Inventors: David Ross MISSIMER, Raleigh, NC (US); George Douglas CRUICKSHANKS, Raleigh, NC (US)

(21) Appl. No.: 17/313,665

(22) Filed: May 6, 2021

Related U.S. Application Data
(60) Provisional application No. 63/022,432, filed on May 9, 2020.

(51) Int. Cl. G06K 7/10; H04L 29/06; H04L 12/723

(52) U.S. Cl. CPC G06K 7/10138; H04L 45/50; H04L 69/18; H04L 69/08

(57) ABSTRACT

Example systems and methods for controlling communication protocols for multi-protocol interrogators are provided herein. In various implementations a multi-protocol interrogator is provided that is capable of exchanging data with a transponder according to a plurality of protocols and is configured to transmit a control signal indicating a preferred protocol from the plurality of protocols over a radio interface. Multi-protocol transponders are also provided that are configured to receive and recognize the control signal, and respond only on the signaled, preferred protocol.

### RELATED APPLICATIONS

This patent application claims the benefit under 35 U.S.C. § 119(e) to U.S. Provisional Patent Application No. 63/022,432, filed on May 9, 2020, entitled CONTROL PROTOCOL FOR MULTI-PROTOCOL TRANSPONDER, the disclosure of which is incorporated herein by reference in its entirety as a part of this document.

### TECHNICAL FIELD

The various embodiments described herein generally relate to radio frequency identification (RFID) systems and more particularly to multi-protocol RFID readers and tags that can be used for multiple applications.

### BACKGROUND

RFID technology harnesses electromagnetic fields to transfer data wirelessly. One of the primary uses for RFID technology is the automatic identification and tracking of objects via RFID tags, which may be attached or incorporated into a variety of objects. Examples include credit cards, passports, license plates, identity cards, cellphones/mobile devices, etc. RFID technology also has applications in numerous areas, including, but not limited to, electronic tolling, parking access, border control, payment processing, asset management, and transportation. Thus, for example, a license plate that includes an RFID tag may be used for the purposes of electronic toll collection (ETC), electronic vehicle registration (EVR), border crossing etc.

Multi-protocol RFID interrogators provide an ability to communicate to a RFID tag via one of multiple protocols.

Currently in the USA there are a number of different RFID protocols in use for various applications, such as for example, electronic toll collection (ETC) applications. Typically, for ETC applications, one specific toll agency (which defines a geographic area from a road system standpoint) will have a single protocol which is considered their ‘home’ or ‘native’ protocol. Patrons of that toll agency's ETC system will purchase an RFID tag from that agency, and those RFID tags are commonly single-protocol in nature. If those patrons travel to a different geographic area serviced by a different toll agency, then their toll tag may not be processed at different ETC systems if that toll agency uses a different native protocol. This situation may not be viewed positively by the toll patron and multiple approaches to solving this issue have been attempted.

One approach has been to expand the geographic area serviced by the native protocol so that the single protocol RFID tag covers the travel scope of a larger percentage of toll patrons. Multiple agencies may align on a single native protocol technology and develop the means to exchange ETC transaction data between members. An example of this is the Inter-Agency Group (IAG) creation of the EZPass system covering the northeast and portions of the mid-west of the United States.

Another approach has been to issue multi-protocol RFID tags to toll patrons which desire to use ETC systems outside of their home area. In the past this approach has had a focus on certain geographic areas with a limited set of protocols in use. Although it is feasible to provide for an RFID tag which supports every protocol in use in the USA, in the past this has been a complex and high cost solution due to the total number of protocols in the USA. Today, some consolidation of protocols is taking place, and a reduced number of protocols will continue in active use across the USA over the coming several years. The multi-protocol RFID tags of today may typically respond to each protocol which is supported in the RFID tag.

A third approach has been to utilize multi-protocol RFID readers (or interrogator) to read tags of any supported protocol as the toll patron moves amongst geographic areas. The multi-protocol RFID reader broadcasts a number of different protocols in time sequence in order to read a RFID tag of any of those protocols. In the past the number of protocols needed to be broadcast to support any tag type was too large for high speed ETC applications. Today, consolidation of protocols is taking place, and it is feasible to broadcast and process tags of the reduced number of primary protocols even in high speed applications.

All three of these approaches are in use in some part of the USA today. RFID tags in vehicles can move to any geographic area, which results in multi-protocol RFID tags directly interacting with multi-protocol RFID readers. This combination is the least desirable from a solution standpoint with a single multi-protocol RFID tag responding to as many protocols as broadcast by the multi-protocol RFID reader. This results in multiple, different identifiers being associated with a given vehicle and causes unnecessary consumption of radio communication time to obtain what is mostly redundant data. This unnecessary consumption of radio communication time can result in degradation of ETC system performance.

One attempt to address the diverse needs of the various geographic areas may be to have a multi-protocol RFID tag that only responds on a single protocol at any particular toll point in a geographic area.

A conventional approach would be to integrate GPS information into the RFID tag's decision of which protocol to respond to. Because toll points are at fixed locations, specific GPS boundaries can be set to define which protocol is in use. Some disadvantages of this approach are the extra cost of GPS functionality, additional processing required within the RFID tag, and the need for means to update the GPS boundaries as toll points are added or removed from an ETC system.

### SUMMARY

Embodiments herein provide for a multi-protocol interrogator, capable of exchanging data with a transponder according to a plurality of protocols, configured to transmit a control signal indicating a preferred protocol from the plurality of protocols over a radio interface. Embodiments herein also provide for a multi-protocol transponder configured to receive and recognize the control signal, and respond only on the signaled, preferred protocol.

According to an aspect, the multi-protocol transponder can be placed within a vehicle to serve as an RFID tag in an electronic toll collection (ETC) application.

Other features and advantages of the present inventive concept should be apparent from the following description which illustrates by way of example aspects of the present inventive concept.

### BRIEF DESCRIPTION OF DRAWINGS

The following figures provide illustrations of the present invention. They are intended to further describe and clarify the invention, but not to limit scope of the invention.

FIG. 1 shows a diagram illustrating an exemplary RFID system in accordance with embodiment described herein.

FIG. 2 is a flow chart illustrating a method of signaling and responding to a preferred protocol in accordance with embodiments herein.

FIG. 3 is a block diagram illustrating an exemplary wired or wireless system in accordance with embodiments herein.

Like numbers are generally used to refer to like components. The drawings are not to scale and are for illustrative purposes only.

### DETAILED DESCRIPTION

While certain embodiments are described, these embodiments are presented by way of example only, and are not intended to limit the scope of protection. The methods and systems described herein may be embodied in a variety of other forms. Furthermore, various omissions, substitutions, and changes in the form of the example methods and systems described herein may be made without departing from the scope of protection.

Embodiments described herein add the capability for a multi-protocol RFID reader (also referred to as an interrogator) to transmit a signal indicating a preferred protocol from the multiple protocols over a radio interface. Embodiments herein also provide for RFID tags that have the capability to recognize this signaling, and are configured then to respond only on the signaled, preferred protocol.

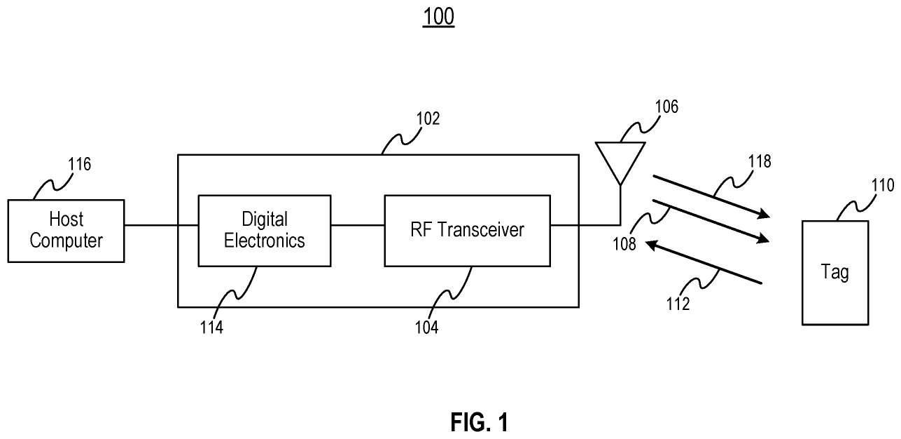

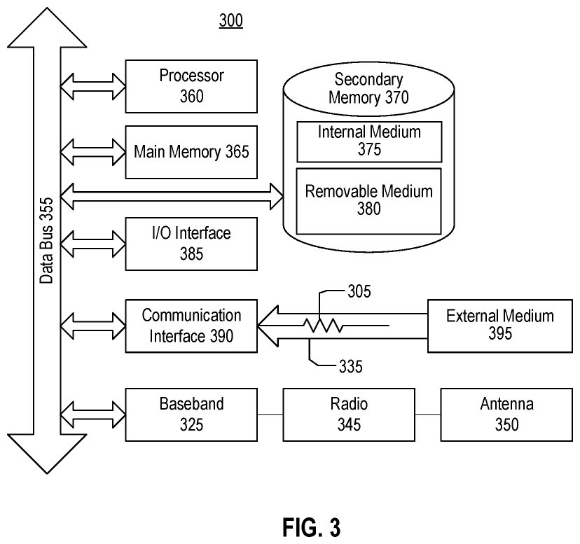

FIG. 1 shows a diagram illustrating an exemplary RFID system 100 in accordance with one embodiment described herein. In system 100, RFID interrogator 102 (sometimes also referred to as an RFID reader or simply reader) communicates with one or more RFID tags 110. Data can be exchanged between interrogator 102 and RFID tag 110 via radio transmit signal 108 and radio receive signal 112. RFID interrogator 102 comprises RF transceiver 104, which contains transmitter and receiver electronics, and antenna 106, which are configured to generate and receive radio transmit signal 108 and radio receive signal 112, respectively. Exchange of data can be accomplished via electromagnetic or electrostatic coupling in the RF spectrum in combination with various modulation and encoding schemes. In some embodiments, the RFID interrogator may be implemented as system 300 of FIG. 3.

RFID tag 110 is a transponder that can be attached to an object of interest and act as an information storage mechanism. The RFID tag 110 may include an antenna and digital electronics (not shown) which may include a memory interfaces with a decoder. Firmware instructions used to control the operation of RFID tag 110 can be stored in memory, along with instructions for communications with RFID interrogator 102 and can be used to control responding to inquiries from RFID interrogator 102. Similarly, digital electronics contained therein may perform the coding of receive signal 112. Coding and decoding may be based on the protocol used to exchange data with the RFID interrogator 102. Thus, RFID tag 110 facilitates the responding to inquires with the RFID interrogator when it is within range of the RF field emitted by antenna 106. Together, RF transceiver 104 and digital electronics 114 comprise reader 102. Finally, digital electronics 114 and can be interfaced with an integral display and/or provide a parallel or serial communications interface to a host computer or industrial controller, e.g. host computer 116.

RFID tag 110 may be active or passive. Active RFID tags are powered by an internal battery and are typically read/write, e.g., tag data can be rewritten and/or modified. An active tag's memory size varies according to application requirements. For example, some systems operate with up to 1 MB of memory. In a read/write RFID work-in-process system, an active RFID tag might give a machine a set of instructions, and the machine would then report its performance to the tag. This encoded data would then become part of the tagged part's history. The battery-supplied power of an active tag generally gives it a longer read and write range. The tradeoff is greater size, greater cost, and a limited operational life.

Passive RFID tags operate without a separate external power source and obtain operating power generated from radio signal, such as radio transmit signal 108. For example, passive RFID tags power themselves by rectifying the RF signal emitted by the RFID interrogator. Consequently, the range of transmit signal 108 determines the operational range of RFID tag 110. Passive tags are consequently much lighter than active tags, less expensive, and offer a virtually unlimited operational lifetime. The tradeoff is that they may have shorter read ranges than active tags and require a higher-powered interrogator. Read-only tags are typically passive and are programmed with a unique set of data (e.g., 32 to 128 bits of data) that cannot be modified. Not all passive tags are read-only tags.

RF transceiver 104 transmits RF signals to RFID tag 110, and receives RF signals from RFID tag 110, via antenna 106. The data in transmit signal 108 and receive signal 112 can be contained in one or more bits for the purpose of providing identification and other information relevant to the particular RFID tag application. Interrogator 102 can emit radio transmit signals 108 in ranges of anywhere from one inch to 100 feet or more, depending upon the power output and the radio frequency used. The RFID interrogator may be configured to use one or more frequency ranges, for example, a low-frequency range (e.g., 30-300 KHz), high-frequency range (e.g., 3-30 MHz), an ultra-high frequency range (e.g., 300 MHz to 3 GHz), and super high-frequency range (e.g., 3 GHz to 30 GHz). Low-frequency and high-frequency systems have short reading ranges and lower system costs, and are commonly used in security access, asset tracking, and animal identification applications. Ultra-high frequency systems offer long read ranges, e.g., greater than 90 feet, high reading speeds, and are used for such applications as railroad car tracking and automated toll collection, however, the higher performance of high-frequency RFID systems 100 incurs higher system costs.

When RFID tag 110 passes within the range of the radio frequency magnetic field emitted by antenna 106, RFID tag 110 is excited and transmits data back to RFID interrogator 102. A change in the impedance of RFID tag 110 can be used to signal the data to RFID interrogator 102 via receive signal 112. The impedance change in RFID tag 110 can be caused by producing a short circuit across the tag's antenna connections (not shown) in bursts of very short duration. RF transceiver 104 senses the impedance change as a change in the level of reflected or backscattered energy arriving at antenna 106.

In some embodiments, RFID system 100 may comprise one more RFID interrogators 102, one or more antennas 106, and one or more RFID tags 110. For example, the RFID system 100 may include a RFID interrogator 102 having a one or more antennas 106 or multiple RFID interrogators each having one or more antennas. Each RFID interrogator 102 may be able to exchange data with any number of RFID tags 110 that enter the broadcast range of the RFID interrogator 102. One common example of multiple antennas configured to transmit signals in a particular area is antennas coupled to one or more RFID interrogators over multiple lanes of traffic for roadway tolling.

RFID interrogator 102 may be configured to exchange data with the RFID tag 110 using one or more protocols. Generally, a protocol is a set of rules defining commands from the RFID interrogator and responses from the RFID tag 108 that allows the two entities to communicate. In various embodiments, the RFID interrogator 102 may be a multi-protocol interrogator that is configured to use multiple protocols. Example protocols include, but are not limited to, ISO 18000-63, ISO 18000-62, Transcore Sego™, Kapsch TDM (EZ-PASS™), Caltrans Title-21, ASTMv6 and ISO 10374. Further, a variety of types of antennas may be used for emitting radio transmit signal 108 using the multiple protocols. Examples of types of antennas include, but are not limited to, linear polarized antennas or circular polarized antennas, such as Patch and Yagi type antennas, and other types of antennas, as will be apparent to an individual of skill in the art upon reading the present disclosure.

Digital electronics 114, which can comprise a microprocessor with RAM, performs decoding and reading of receive signal 112. The digital electronics 114 may include a memory interfaces with a decoder. Firmware instructions used to control the operation of interrogator 102 can be stored in memory, along with RFID instructions that can be communicated to RFID tag 110 and can be used to control acquisition of information from RFID tags 110. Similarly, digital electronics 114 performs the coding of transmit signal 108. Coding and decoding may be based on the protocol used to exchange data with the RFID tag 110. Thus, RFID interrogator 102 facilitates the reading or writing of data to RFID tags, e.g. RFID tag 110 that are within range of the RF field emitted by antenna 106. Together, RF transceiver 104 and digital electronics 114 comprise reader 102. Finally, digital electronics 114 can be interfaced with an integral display and/or provide a parallel or serial communications interface to a host computer or industrial controller, e.g. host computer 116. In various embodiments, host computer 116 may be implemented as system 300 of FIG. 3. As noted above, the RFID interrogator 102 may be a multi-protocol RFID interrogator capable of exchanging data with the RFID tag 110 using multiple protocols. The multi-protocol RFID interrogator 102 transmits a plurality of radio transmit signals 108, each signal 108 uses a corresponding protocol. The multi-protocol RFID interrogator 102 may be configured to transmit a control signal 118, via antenna 106, indicating a preferred protocol. In various embodiments, the multi-protocol RFID interrogator 102 may contain instructions for encoding the control signal 118 with information indicative of the preferred protocol. In some embodiments, the information may be an indication that communications should be inhibited on the immediately following protocol (e.g., do not respond using the succeeding protocol if the signal is understood) or not. Alternatively, or in combination, the information may be an indication that the succeeding protocol is the preferred protocol and should be used for communications.

The RFID tag 110 may be configured to recognize the control signal 118 and respond using only preferred protocol indicated in the control signal 108. For example, the RFID tag 110 may store instructions for decoding and/or processing the received signal, thereby extracting the control protocol encoded therein. The RFID tag 110 may be a single protocol RFID tag or a multi-protocol RFID tag. If the RFID tag 110 is a multi-protocol RFID tag configured to recognize (e.g., decode) the control signal 118 (referred to herein as a preferred protocol tag or PPT), then the PPT 110 uses the signaled, preferred protocol. If the multi-protocol RFID tag 110 does not recognize the control signal 118, then it may ignore this signal and respond to each protocol as broadcast by the multi-protocol RFID interrogator 102. If the tag 110 is a single protocol tag, then it may respond to only the protocol for which it is configured.

The control signal 118 may utilize a control protocol added to the multi-protocol behavior of the multi-protocol RFID interrogator 102. In some embodiments, the control protocol can be broadcast by the multi-protocol RFID interrogator 102 prior to each interrogation signal 108 corresponding to each protocol of the multiple protocols, for example. The control protocol may indicate whether the multi-protocol RFID interrogator 102 prefers a response on the protocol succeeding the control protocol 118 or whether the PPT 110 should inhibit its response on the protocol which immediately follows the control protocol. In some embodiments, the control protocol may only indicate whether the multi-protocol RFID interrogator 102 prefers a response on the protocol succeeding the control protocol 118. In which case, the PPT 110 may be capable of recognizing such preference and is configured to inhibit its response to other protocols. Alternatively, the control signal 118 may be broadcast prior to all of the radio transmit signals 108 and repeat the control signal 118 after all signals 108 have been transmitted.

The control signal 118 of the control protocol is defined in a manner that does not cause unwanted behavior in any RFID tags, including those tags with no knowledge of what the control signal 118 is (e.g., single protocol or non-PPT tags). If a single protocol tag encounters a multi-protocol RFID interrogator 102 emitting the control signal 118, with the signaling defined in a manner to not impact the tag's respond to the multi-protocol reader, the single RFID tag will respond to the broadcast protocol which the tag is designed to process (which may or may not correspond to the preferred protocol). Similarly, if a multi-protocol tag which does not recognize the signaling encounters a multi-protocol RFID interrogator 102 emitting the control signal 118, with signaling defined in a manner to not impact the tag's respond to the multi-protocol reader, the multi-protocol RFID tag will respond to each broadcast protocol which the tag is designed to process.

The control signal 118 may also be defined based on various different criteria. For example, the control signal 118 may be short in duration, so to minimize extra overhead (in radio transmission time and processing load on a processor). As another example, the control signal 118 may be communicated as a waveform that provides adequate spectral occupancy, such that the control signal does not increase potential interference effects on adjacent RFID readers. These are only some examples of criteria for defining the control signal 118, and other criteria could be considered.

If a PPT encounters a toll point using a multi-protocol RFID interrogator 102 emitting the control signal 118, the PPT will respond to the preferred protocol which the tag is designed to process. That is, if the signaled preferred protocol is one that the PPT is designed to process, then the PPT will respond to the preferred protocol. Otherwise, the PPT will operate as though it was a standard multi-protocol RFID tag (e.g., respond to each broadcast protocol which the tag is designed with). In some embodiments, if the PPT is not designed to process the preferred protocol but recognizing the control signal 118, then the PPT may be configured to respond to a default or predetermined protocol, thereby reducing redundant data. If a PPT encounters a multi-protocol RFID interrogator that does not emit the control signal 118, the tag will respond to each broadcast protocol which the tag is designed to process.

Each protocol is designed to use a predefined signaling to mark the beginning of a communication. For example, in the case of the TDM protocol, this signaling is a pulse having a width of 20 μs. In the case of ISO 18000-6C/63 (ISOC), this is a sequence of defined bits, known as the preamble, to mark the start of a command frame. In the case of SeGo, this is also a sequence of defined bits, known as the preamble, to mark the start of a command frame.

An example control signal 118 signaling of the multi-protocol control protocol may a predefined signal recognized by the PPT. In one example, the control protocol may be defined as preset time sequence of pulse having predetermined power on intervals, followed by a 12.5 μs data low, followed by a 3.125 μs data high, followed by a 3.125 μs data low, finally followed by a power off interval. This is only one example of a control protocol, and other specific signaling for the control protocol could be defined.

The PPT 110, once activated, will always search for this control signaling. The presence or absence of the control signal 118 may be indicative of the preferred protocol. For example, in one embodiment, if this control signaling is present, then the PPT 110 may be configured to inhibit its response on the protocol which immediately follows the signal. If this control signaling is not present, then the PPT 110 may be configured to respond to the protocol which immediately follows in the manner defined by that protocol. Conversely, in another embodiment, if the control signaling is not present, the PPT 110 may be configured to inhibit its response on the protocol which immediately follows the signal. If this control signaling is present, then the PPT 110 may be configured to respond to the protocol which immediately follows in the manner defined by that protocol. In yet another embodiment, the control signal 118 may include data that the PPT may decode identifying the preferred protocol, regardless whether the identified protocol immediately follows the signal 118 or not.

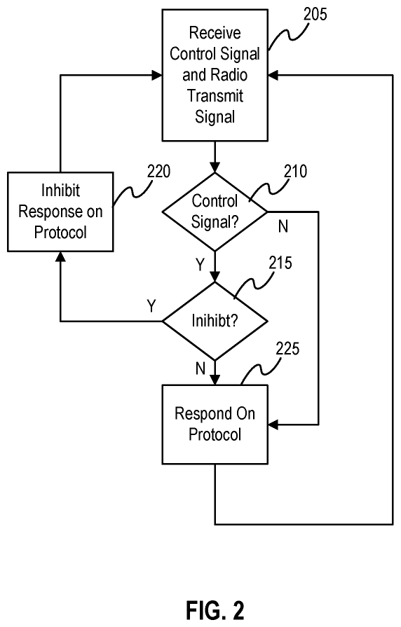

FIG. 2 is a flow chart illustrating a method of signaling and responding to a preferred protocol in accordance with embodiments herein. The steps illustrated in FIG. 2 may be performed by tag, such as the RFID tag 110 described in connection to FIG. 1.

A simplified example is provided in connection to FIG. 2, where the tag is a multi-protocol tag that understands how to process (e.g., decode) the received signal according to protocols A, B, and C. If that multi-protocol tag encounters an interrogator that is only broadcasting protocol A, then the multi-protocol tag only responds on protocol A. If the interrogator is broadcasting protocols A, B, and C, then multi-protocol tag may respond on A, B, and C (e.g., it responds 3 different times with mostly redundant data, but for protocol based differences). This situation is undesirable.

Accordingly, as described above, embodiments herein provide an improvement by providing the interrogator the capability to indicate the preferred protocol through control signal 118. For example, the interrogator may signal whether to respond or not respond before each broadcast protocol, and tags may be provided with the ability to understand that signaling. Accordingly, in one example with reference to FIG. 2, the interrogator may broadcast a control signal 118 preceding each radio transmit signal 108, which each radio transmit signal 108 is communicated according to protocols A, B, and C. The control signal may be “Inhibit=yes” or “inhibit=no,” which indicates to respond on the succeeding protocol (inhibit=no) or not responding to the succeeding protocol (inhibit=yes).

In one example, at step 205, the multi-protocol tag receives a control signal 118 and a radio transmit signal 108 immediately following control signal 118. If the multi-protocol tag understands the control signal (YES at step 210) and encounters Inhibit=yes followed by protocol A, inhibit=no followed by protocol B, and inhibit=yes followed by protocol C (at step 215), then the multi-protocol tag will only respond on protocol B (step 225) and inhibit responses on others (step 220). If the multi-protocol tag does not recognize this new signaling at step 210 (NO at step 210), then it will continue to respond on to each radio transmit signal 108 according to each protocol A, B, and C.

While embodiments of the control signal 118 are indicating whether to “inhibit” or not, other implementations are possible. For example, the control signal may be “respond” or not. Thus, at step 215, if the control signal 118 indicates respond=yes, then the multi-protocol tag may proceed to step 225 and respond on the indicated protocol.

As another example, the multi-protocol tag may encounter a control signal 118 that includes all Inhibit=yes, protocol A; inhibit=no, protocol B; and inhibit=yes, protocol C prior to any of protocols A, B, and C at step 205. In this case, the multi-protocol tag may understand this signal (at step 210) as indicating protocol B is the preferred protocol (step 215) and to respond (step 225) according to protocol B and not respond to other protocols (step 220).

In yet another example, step 210 may include a determination of whether a control signal 118 is present or absent. For example, at step 205 the tag may receive a signal including at least a radio transmit signal 108. At step 210, if a control signal 118 is present (Yes at step 210), the tag determines to respond on that protocol at step 225. If at step 210, the control signal 118 is not present, then the tag may proceed to step 220 and does not respond. Alternatively, the presence of the control signal 118 may indicate not to respond (e.g., YES at step 210 may cause the tag to proceed to step 220), while absence of the control signal 118 may cause the tag to proceed to step 225. In these examples, the decision to inhibit at step 215 and the determination of whether there is a control signal 118 or not at step 210 may be merged.

The embodiments herein may be applicable to ultra-high frequency (UHF) RFID protocols used in use for ETC applications. However, the scope of this disclosure is not intended to be limited to only UHF RFID protocols and may be applicable to any RFID protocol used for any frequency range and/or RFID application.

As noted herein, the RFID tag 110 (e.g., any one of a single or multi-protocol tags or PPT) may be used in various ETC applications and may be a multi-frequency switch tag. For example, the RFID tag 110 may include at least one UHF RFID module which can be configured to be used in high occupancy vehicle (HOV) lanes, while an HF RFID module may be included that is configured to be used in single occupancy vehicle (SOV) lanes. Hence, the RFID tag 110 permits a driver to switch between HOV operations and SOV operations using a single RFID switch tag. In such embodiments, the tag 110 can include a switching mechanism that allows the user to switch between the UHF and HF tags as required. U.S. patent application Ser. No. 15/160,982, entitled “Multi-Frequency Radio Frequency Identification Tag,” filed May 20, 2016, which in turn claims priority to U.S. provisional Patent Application No. 62/165,167, also entitled “Multi-Frequency Radio Frequency Identification Tag,” filed May 21, 2015; U.S. patent application Ser. No. 14/818,257, entitled “Methods and Apparatus for Preserving Privacy in an RFID System,” filed Aug. 4, 2015, which in turn claims priority to U.S. patent application Ser. No. 14/229,786, now U.S. Pat. No. 9,098,790, entitled “Methods and Apparatus for Preserving Privacy in an RFID System,” filed Mar. 28, 2014, which in turn claims priority to U.S. patent application Ser. No. 13/736,819, now U.S. Pat. No. 8,710,960, entitled “Methods and Apparatus for Preserving Privacy in an RFID System,” filed Jan. 8, 2013, which in turn claims priority to U.S. patent application Ser. No. 12/364,158, now U.S. Pat. No. 8,350,673, entitled “Methods and Apparatus for Preserving Privacy in an RFID System,” filed Feb. 2, 2009, which in turn claims priority to U.S. provisional Patent Application No. 61/025,000, also entitled “Method and Apparatus for Preserving Privacy in RFID Systems,” filed Jan. 31, 2008; U.S. patent application Ser. No. 14/480,458, entitled “RFID Switch Tag,” filed Sep. 8, 2014, which in turn claims priority to U.S. patent application Ser. No. 13/465,829, now U.S. Pat. No. 8,844,831, entitled “RFID Switch Tag,” filed May 7, 2012, which in turn claims priority to U.S. provisional Patent Application Nos. 61/487,372, filed May 18, 2011 and 61/483,586, filed May 6, 2011, both entitled “RFID Switch Tag;” U.S. patent application Ser. No. 14/578,196, entitled “RFID Switch Tag,” filed Dec. 19, 2014, which in turn claims priority to U.S. patent application Ser. No. 14/060,407, now U.S. Pat. No. 8,944,337, entitled “RFID Switch Tag,” filed Oct. 22, 2013, which in turn claims priority to U.S. patent application Ser. No. 13/465,834, now U.S. Pat. No. 8,561,911, entitled “RFID Switch Tag,” filed May 7, 2012, which in turn claims priority to U.S. provisional Patent Application Nos. 61/487,372, filed May 18, 2011 and 61/483,586, filed May 6, 2011, both entitled “RFID Switch Tag,” all of which are incorporated herein by reference as if set forth in full; disclose various embodiments of tags that allow switching between modules incorporated within a switchable and/or multi-frequency tag. Similarly, the tag 110 may be a detachable switch tag as described in U.S. patent application Ser. No. 15/160,982, entitled “Multi-Frequency Radio Frequency Identification Tag,” filed May 20, 2016, which in turn claims priority to U.S. provisional Patent Application No. 62/165,167 and U.S. patent application Ser. No. 16/677,444, entitled “Detachable Radio Frequency Identification Tag,” filed Nov. 7, 2019, which in turn claims priority to U.S. provisional Patent Application No. 62/757,018, all of which are incorporated herein by reference as if set forth in full; which disclose various embodiments of tags that allow detachment and switching between modules incorporated within a switchable and/or multi-frequency tag. Any of these mechanisms can be used in accordance with switch tag 111.

According to one exemplary embodiment, RFID tag 110 can be used in one or more account management applications. For example, RFID tag 110 can be used to track a vehicle for purposes of electronic tolling, parking access, and border control. At least some applications for the RFID switch tag 200 are described in U.S. Pat. Nos. 8,844,831 and 8,944,337, and U.S. patent application Ser. Nos. 14/480,458 and 14/578,196, the disclosures of which are incorporated herein by reference in their entirety.

In some embodiments, access to the memory on the RFID tag 110 can be granted based on a security key. The provision of secure identification solutions is described in U.S. Pat. Nos. 7,081,819, 7,671,746, 8,237,568, 8,322,044, and 8,004,410, the disclosures of which are incorporated by reference herein in their respective entirety.

Multi-frequency RFID tags that can be implemented as the RFID tag 110 are also described in Reissued U.S. Pat. Nos. RE 43,355 and RE 44,691, the disclosures of which are incorporated by reference herein in their respective entirety.

Some applications can require a placement of metallic material (e.g., retro-reflective material, holographic image) over the RFID tag 110. In order to preserve the transmission and reception capabilities of the RFID tag 110, a selective de-metallization process may be employed to treat the metallic material. Selective de-metallization is described in U.S. Pat. Nos. 7,034,688 and 7,463,154, the disclosures of which are incorporated by reference herein in their respective entirety.

FIG. 3 is a block diagram illustrating a wired or wireless system 300 according to various embodiments that may utilize the systems and methods described above in reference to the other Figures. For example, the system 300 could be implemented as one or more components of the RFID interrogator 102 of FIG. 1. In various embodiments, the system 300 may be a conventional personal computer, computer server, personal digital assistant, smart phone, tablet computer, or any other processor enabled device that is capable of wired or wireless data communication. A person having ordinary skill in the art can appreciate that other computer systems and/or architectures may be used without departing from the scope of the present inventive concept.

The system 300 preferably includes one or more processors, such as processor 360. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 360.

The processor 360 is preferably connected to a data bus 355. The data bus 355 may include a data channel for facilitating information transfer between storage and other peripheral components of the system 300. The data bus 355 further may provide a set of signals used for communication with the processor 360, including a data bus, address bus, and control bus (not shown). The data bus 355 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPM”), IEEE 696/S-100, and the like.

The system 300 preferably includes a main memory 365 and may also include a secondary memory 370. The main memory 365 provides storage of instructions and data for programs executing on the processor 360. For example, the main memory 365 may include instructions for generating and transmitting the control signal 118 and/or radio transmit signals 108 of FIG. 1 and processing the radio receive signal 112 in accordance with one or more protocols. Additionally, the main memory 365 may store one or more protocols as a set of rules for exchanging data with RFID transponders. The main memory 365 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 370 may optionally include an internal memory 375 and/or a removable medium 380, for example a floppy disk drive, a magnetic tape drive, a compact disc (“CD”) drive, a digital versatile disc (“DVD”) drive, etc. The removable medium 380 is read from and/or written to in a well-known manner. Removable medium 380 may be, for example, a floppy disk, magnetic tape, CD, DVD, SD card, etc.

The removable medium 380 is a non-transitory computer readable medium having stored thereon computer executable code (i.e., software) and/or data. The computer software or data stored on the removable medium 380 is read into the system 300 for execution by the processor 360.

In alternative embodiments, secondary memory 370 may include other similar means for allowing computer programs or other data or instructions to be loaded into the system 300. Such means may include, for example, an external medium 395 and a communication interface 390. Examples of external medium 395 may include an external hard disk drive or an external optical drive, or and external magneto-optical drive.

Other examples of secondary memory 370 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are a removable medium 580 and a communication interface 390, which allow software and data to be transferred from an external medium 395 to the system 300.

The system 300 may also include an input/output (“I/O”) interface 385. The I/O interface 385 facilitates input from and output to external devices. For example, the I/O interface 385 may receive input from a keyboard or mouse and may provide output to a display. The I/O interface 385 is capable of facilitating input from and output to various alternative types of human interface and machine interface devices alike.

The communication interface 390 allows software and data to be transferred between system 300 and external devices (e.g. printers), networks, or information sources. For example, computer software or executable code may be transferred to system 300 from a network server via communication interface 390. Examples of communication interface 390 include, for example, but not limited to, a modem, a network interface card (“NIC”), a wireless data card, a communications port, a PCMCIA slot and card, an infrared interface, and an IEEE 1394 fire-wire.

The communication interface 390 preferably implements industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via the communication interface 390 are generally in the form of electrical communication signals 305. In one exemplary embodiment, these electrical communication signals 305 are provided to the communication interface 390 via a communication channel 335. In one embodiment, the communication channel 335 may be a wired or wireless network, or any variety of other communication links. The communication channel 335 carries the electrical communication signals 305 and can be implemented using a variety of wired or wireless communication means including wire or cable, fiber optics, conventional phone line, cellular phone link, wireless data communication link, radio frequency (“RF”) link, or infrared link, just to name a few.

Computer executable code (i.e., computer programs or software) is stored in the main memory 365 and/or the secondary memory 370. Computer programs can also be received via communication interface 590 and stored in the main memory 365 and/or the secondary memory 370. Such computer programs, when executed, enable the system 550 to perform the various functions of the present invention as previously described.

In this description, the term “computer readable medium” is used to refer to any non-transitory computer readable storage media used to provide computer executable code (e.g., software and computer programs) to the system 300. Examples of these media include the main memory 365, the secondary memory 370 (including the internal memory 375, the removable medium 380, and the external medium 395), and any peripheral device communicatively coupled with the communication interface 390 (including a network information server or other network device). These non-transitory computer readable mediums are means for providing executable code, programming instructions, and software to the system 300.

In one embodiment implemented using software, the software may be stored on a computer readable medium and loaded into the system 300 by way of the removable medium 380, the I/O interface 385, or the communication interface 390. In such an embodiment, the software is loaded into the system 300 in the form of electrical communication signals 305. The software, when executed by the processor 360, preferably causes the processor 360 to perform the inventive features and functions previously described herein.

The system 300 also includes optional wireless communication components that facilitate wireless communication over a voice and over a data network. The wireless communication components comprise an antenna system 355, a radio system 345 and a baseband system 325. In the system 300, radio frequency (“RF”) signals are transmitted and received over the air by the antenna system 355 under the management of the radio system 345.

In one embodiment, the antenna system 300 may comprise one or more antennae and one or more multiplexors (not shown) that perform a switching function to provide the antenna system 300 with transmit and receive signal paths. In the receive path, received RF signals can be coupled from a multiplexor to a low noise amplifier (not shown) that amplifies the received RF signal and sends the amplified signal to the radio system 345.

In alternative embodiments, the radio system 345 may comprise one or more radios that are configured to communicate over various frequencies. In one embodiment, the radio system 345 may combine a demodulator (not shown) and modulator (not shown) in one integrated circuit (“IC”). The demodulator and modulator can also be separate components. In the incoming path, the demodulator strips away the RF carrier signal leaving a baseband receive data signal, which is sent from the radio system 345 to the baseband system 325.

The baseband system 325 decodes the baseband signal from radio 345 to extract digital information which is then passed to the processor 360 for additional processing. The baseband system 325 also encodes the digital signals for transmission and generates a baseband transmit data signal that is routed to the modulator portion of the radio system 345. The modulator mixes the baseband transmit data signal with an RF carrier signal generating an RF transmit signal that is routed to the antenna system 355 and may pass through a power amplifier (not shown). The power amplifier amplifies the RF transmit signal and routes it to the antenna system 355 where the signal is switched to the antenna port for transmission.

The baseband system 325 may also be communicatively coupled with the processor 360. The processor 360 has access to main memory 365 and/or secondary memory 370. The processor 360 is preferably configured to execute instructions (i.e., computer programs or software) that can be stored in the main memory 365 or the secondary memory 370. Computer programs can also be received from the baseband system 325 and stored in the main memory 365 or in secondary memory 370, or executed upon receipt. Such computer programs, when executed, enable the system 300 to perform the various functions of the present invention as previously described. For example, the main memory 365 may include various software modules (not shown) that are executable by processor 360.

Claims and their equivalents are intended to cover such forms or modifications as would fall within the scope and spirit of the protection. The example apparatuses, methods, and systems disclosed herein can be applied wireless communication devices incorporating HF and/or UHF RFID reader capabilities. The various components illustrated in the figures may be implemented as, for example, but not limited to, software and/or firmware on a processor, ASIC/FPGA/DSP, or dedicated hardware. Also, the features and attributes of the specific example embodiments disclosed above may be combined in different ways to form additional embodiments, all of which fall within the scope of the present disclosure.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein can be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described can be implemented in hardware, software, firmware, or any combination thereof If implemented in software, the functions may be stored as one or more instructions or code on a non-transitory computer-readable storage medium or non-transitory processor-readable storage medium. The steps of a method or algorithm disclosed herein may be embodied in processor-executable instructions that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

Although the present disclosure provides certain example embodiments and applications, other embodiments that are apparent to those of ordinary skill in the art, including embodiments which do not provide all of the features and advantages set forth herein, are also within the scope of this disclosure.

What is claimed is:

1. A radio frequency identification (RFID) system comprising:
an RFID reader configured to utilize a first plurality of protocols for exchanging data, the RFID reader configured to transmit a signal indicative of a preferred protocol of the first plurality of protocols; and
an RFID transponder configured to utilize a second plurality of protocols, the RFID transponder configured to communicate with the RFID reader using the preferred protocol in response to receiving the signal.

2. The RFID system of claim 1, wherein the RFID transponder is configured to determine the preferred protocol based on the presence or absence of the signal.

3. The RFID system of claim 1, wherein the RFID transponder is configured to determine the preferred protocol based on decoding the signal.

4. The RFID system of claim 1, wherein the RFID transponder is configured to communicate with the RFID reader using the preferred protocol if the RFID transponder can decode the signal.

5. The RFID system of claim 1, wherein, if the RFID transponder cannot decode the signal, the RFID transponder communicates with the RFID reader using each of the first plurality of protocols that overlaps with the second plurality of protocols.

6. The RFID system of claim 1, wherein the RFID transponder is configured to communicate with the RFID reader using only the preferred protocol.

7. The RFID system of claim 1, wherein the RFID reader is configured to transmit one or more radio transmit signals for exchanging data, wherein the signal indicative of a preferred protocol is transmitted prior to transmitting the one or more radio transmit signals.

8. The RFID system of claim 7, wherein the one or more radio transmit signals each correspond to a different protocol of the first plurality of the protocols, and wherein the signal indicative of a preferred protocol indicates the preferred protocol by indicating at least one of the radio transmit signal of the plurality of radio transmit signals, wherein the protocol corresponds to the indicated at least one of the radio transmit signal.

9. The RFID system of claim 1, wherein the RFID reader is configured to transmit a plurality of radio transmit signals for exchanging data, each radio transmit signal corresponding to one of the first plurality of protocols, wherein the signal indicative of a preferred protocol comprises a one or more control signals, at least one of which is transmitted prior to one of the plurality of radio transmit signals, wherein the at least one control signal is indicative of whether the protocol of the corresponding radio transmit signal is the preferred protocol.

10. The RFID system of claim 1, wherein the RFID transponder is disposed on a vehicle and the RFID reader is associated with an electronic toll collection (ETC) application.

11. A method for signaling preferential communication protocols using a radio frequency identification (RFID) system, the method comprising:
transmitting, by an RFID reader, a signal indicative of a preferred protocol of a first plurality of protocols, the RFID reader configured to utilize the first plurality of protocols for exchanging data;
receiving the signal by an RFID transponder;
communicating with the RFID, by the RFID reader, using the preferred protocol in response to receiving the signal.

12. The method of claim 11, further comprising determining, by the RFID transponder, the preferred protocol based on the presence or absence of the signal.

13. The method of claim 11, further comprising determining the preferred protocol based on decoding the signal by the RFID transponder.

14. The method of claim 11, wherein the RFID transponder communicates with the RFID reader using the preferred protocol if the RFID transponder can decode the signal.

15. The method of claim 11, wherein, if the RFID transponder cannot decode the signal, the RFID transponder communicates with the RFID reader using each of the first plurality of protocols that overlaps with the second plurality of protocols.

16. The method of claim 11, wherein the RFID transponder communicates with the RFID reader using only the preferred protocol.

17. The method of claim 11, further comprising transmitting, by the RFID reader, one or more radio transmit signals for exchanging data, wherein the signal indicative of a preferred protocol is transmitted prior to transmitting the one or more radio transmit signals.

18. The method of claim 17, wherein the one or more radio transmit signals each correspond to a different protocol of the first plurality of the protocols, and wherein the signal indicative of a preferred protocol indicates the preferred protocol by indicating at least one of the radio transmit signal of the plurality of radio transmit signals, wherein the protocol corresponds to the indicated at least one of the radio transmit signal.

19. The method of claim 11, further comprising transmitting, by the RFID reader, a plurality of radio transmit signals for exchanging data, each radio transmit signal corresponding to one of the first plurality of protocols, wherein the signal indicative of a preferred protocol comprises a one or more control signals, at least one of which is transmitted prior to one of the plurality of radio transmit signals, wherein the at least one control signal is indicative of whether the protocol of the corresponding radio transmit signal is the preferred protocol.

20. The method of claim 11, wherein the RFID transponder is disposed on a vehicle and the RFID reader is associated with an electronic toll collection (ETC) application.
